(19) United States
(12) Patent Application Publication
(10) Pub. No.: US 2007/0217781 A1
(43) Pub. Date: Sep. 20, 2007

(54) Power-off switch structure

(76) Inventor: Tzu Chih Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/376,209

(22) Filed: Mar. 16, 2006

(51) Int. Cl. G03B 7/26

(52) U.S. Cl. 396/301

(57) ABSTRACT

A power-off switch structure is proposed, in which a fastening component is disposed between conducting strips and electrode ends of a battery or a conducting strip is disposed on a slidable component. When the electricity is to be totally cut off, the fastening component can move in between the conducting strips and the electrode ends or the slidable component can be moved away to form an open circuit, thereby totally cutting off the electricity of an electronic device. Because the electronic device won't have any power consumption in the off state, the electricity in the electronic device can be kept for a long time. Therefore, the number of times of replacing or charging the battery can be reduced to enhance the convenience of use.

### BACKGROUND OF THE INVENTION

1. Field of the Invention

The present invention relates to a power-off switch and, more particularly, to a power-off switch structure applied to electronic devices.

2. Description of Related art

Electronic devices play a very important role is every lives of people. Nowadays, it is necessary to use batteries to provide electricity for many electronic devices for normal operations of these electronic devices. For instance, with continual progress of science and technology, digital cameras have gradually replaced conventional cameras. There are many reasons. First, when taking pictures with a digital camera, one can immediately check the photographed pictures through the attached LCD screen of the digital camera. Moreover, the taken pictures can be directly processed into digital data to greatly enhance the convenience. Finally, the volume of a digital camera is generally much smaller than that of a conventional camera, hence much increasing the convenience in portability.

The digital cameras, however, have a problem of large power consumption. When using a digital camera to take pictures, the LCD screen attached will display the images, and this LCD screen is very power-consuming. Therefore, under vigorous research and development of many manufacturers, power-saving chips are implanted into the digital cameras to make them be able to automatically cut off power, thereby accomplishing the object of saving power. This, however, will result in another problem. When the user wants to take pictures again, the digital camera has to activate the power to awaken the image sensor such as charge-coupled device (CCD). This delay time will cause much trouble in operation of the user. Therefore, in order to shorten this delay time, today digital camera still keeps a lowest power output when not in use to accelerate the turn-on speed.

The above way of keeping a lowest power output also causes another problem, i.e., the user can not make sure the next usable time of the digital camera. When a digital camera is not in use for a long time, the electricity in the battery of the digital camera will be depleted. Therefore, when the user wants to use a digital camera not in use for a long time, he has to replace or charge its battery, hence bringing about much trouble and inconvenience of the user.

The present invention aims to propose a power-off switch structure to solve the above problems in the prior art.

### SUMMARY OF THE INVENTION

An object of the present invention is to provide a power-off switch structure, in which a power-off switch is used to isolate conducting strips and a battery so that an electronic device won't have any power consumption when not in use. Therefore, the electricity in the electronic device can be kept for a long time.

Another object of the present invention is to provide a power-off switch structure, which can save power loss to reduce the number of times of replacing or charging the battery and thus enhance the convenience of use.

A power-off switch structure of the present invention comprises at least two conducting strips and a power-off switch. The conducting strips respectively abut against two electrode ends of at least a battery, and are used to provide electricity of the battery for an electronic device. The power-off switch is connected to a fastening component made of insulating material. The fastening component will move in between the conducting strips and the electrode ends to isolate the conducting strips and the battery when the power-off switch is pushed.

Another power-off switch structure of the present invention comprises a first conducting strip and a second conducting strip and a power-off switch. The first conducting strip is disposed on a slidable component. The first and second conducting strips respectively abut against two electrode ends of a battery, and are used to provide electricity of the battery for an electronic device. The power-off switch has a connection portion connected to the slidable component. When the power-off switch is pushed, the connection portion drives the slidable component to move so as to separate the conducting strip on the slidable component from the battery.

### BRIEF DESCRIPTION OF THE DRAWINGS

The various objects and advantages of the present invention will be more readily understood from the following detailed description when read in conjunction with the appended drawing, in which:

FIGS. 1A and 1B are structure diagrams showing the power-off step according to a first embodiment of the present invention;

FIGS. 2A and 1B are structure diagrams showing the power-off step according to a second embodiment of the present invention; and

FIGS. 3A and 3B are structure diagrams showing the power-off step according to a third embodiment of the present invention.

### DETAILED DESCRIPTION OF THE PREFERRED EMBODIMENTS

A power-off switch structure of the present invention is installed on an electronic device such as a digital camera, a mobile phone, or a digital camcorder. The power-off switch structure is manually operated to avoid any power consumption when the electronic device is not in use for a long time. Electricity can thus be maintained even when the electronic device is not in use for a long time.

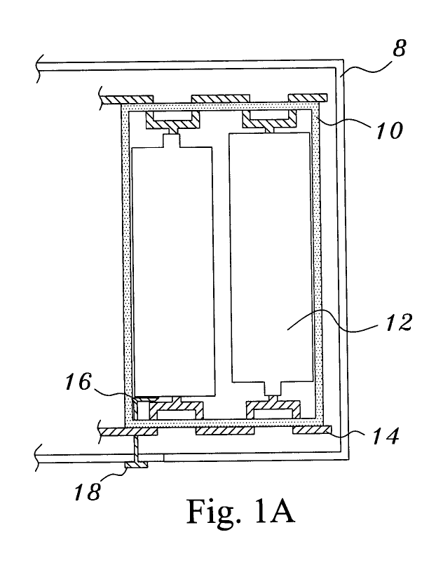

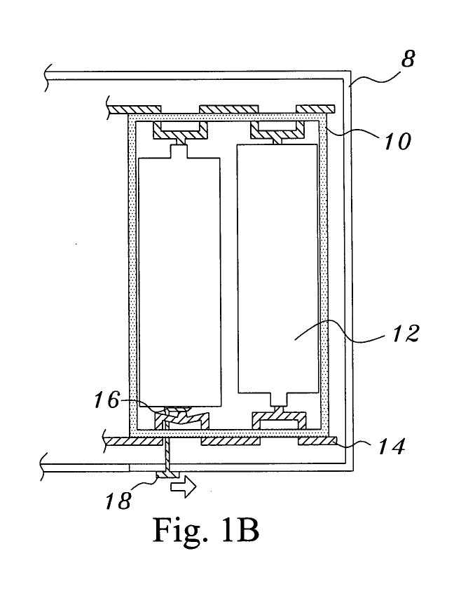

The present invention will be exemplified below with a digital camcorder as the example. FIGS. 1A and 1B are structure diagrams showing the power-off step according to a first embodiment of the present invention. As shown in FIGS. 1A and 1B, a digital camcorder 8 has an accommodating room 10 for installation of two batteries 12. In this embodiment, the batteries 12 are common standard batteries (primary batteries) such as AA batteries, AAA batteries, and so on. The batteries 12 can also be secondary batteries (rechargeable batteries) such as lithium batteries, Ni—Zn batteries, NiMH batteries, Ni—Cd batteries, and so on. Of course, the accommodating room has to change with the shape of the batteries 12. Two resilient metal conducting strips 14 are disposed at upper and lower ends of the accommodating room 10, respectively. These two conducting strips 14 contact the positive electrode end and the negative electrode end of the batteries 12, respectively. The electricity of the batteries 12 is provided to the digital camcorder 8 via these two conducting strips 14. A fastening component 16 made of insulating material is disposed beside the contact points of the conducting strips 14 and the electrode ends of the batteries 12. The fastening component 16 is connected to a power-off switch 18. The power-off switch 18 is disposed on the outside surface of the digital camcorder 8. The power-off switch 18 is manually operated by the user. When the power-off switch 18 is pushed, the fastening component 16 is driven to move in between the conducting strip 14 and the electrode end of one of the batteries 12 to form an open circuit, hence totally cutting off the electricity of the digital camcorder 8.

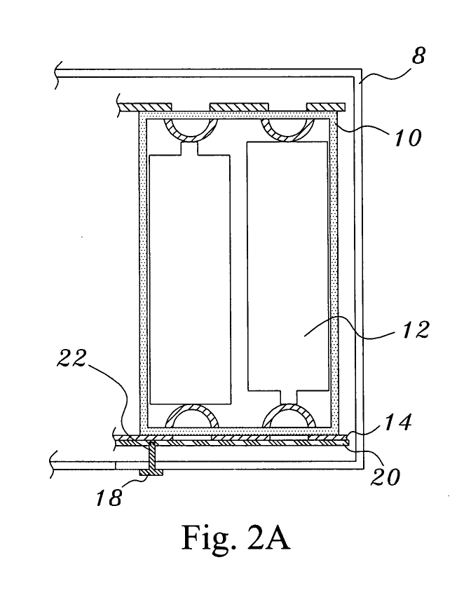

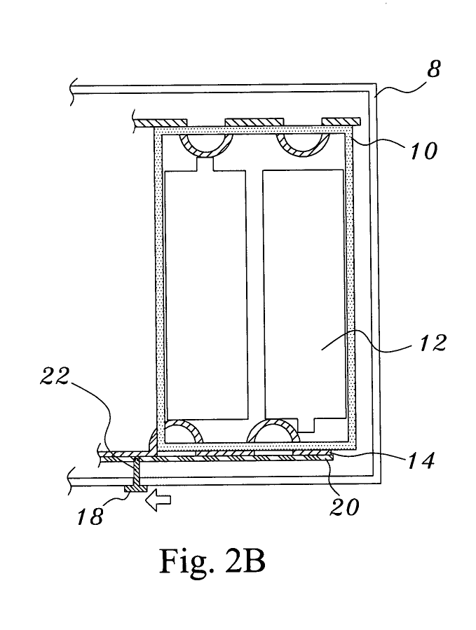

FIGS. 2A and 2B are structure diagrams showing the power-off step according to a second embodiment of the present invention. As shown in FIGS. 2A and 2B, two standard batteries 12 are similarly disposed in the accommodating room 10. A horizontal slidable component 20 is disposed on the room wall at the lower end of the accommodating room 10. Two metal conducting strips 14 are disposed on the room wall at the upper end of the accommodating room 10 and on the slidable component 20, respectively. The electricity of the batteries 12 is provided to the digital camcorder 8 via these two conducting strips 14. The slidable component 20 is also connected with a connection portion 22. The connection portion 22 is connected with the slidable component 20 by means of fastening. The connection portion 22 is also connected with the power-off switch 18. The power-off switch 18 is disposed on the outside surface of the digital camcorder 8 for manual operation of the user. When the power-off switch 18 is pushed, the slidable component 20 moves and drives the conducting strip 14 on the slidable component 20 to leave from the electrode end of one of the batteries 12, hence forming an open circuit and therefore totally cutting off the electricity of the digital camcorder 8.

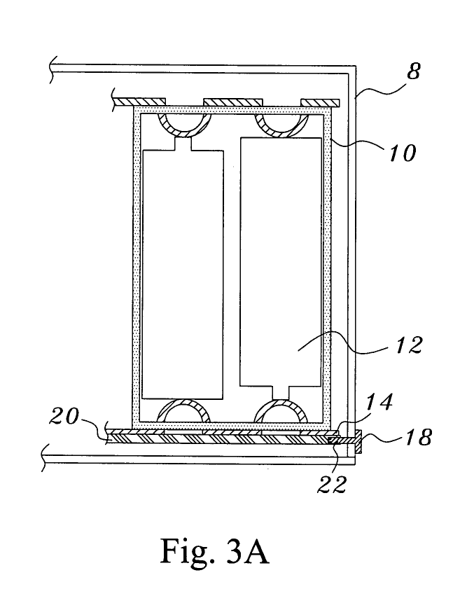

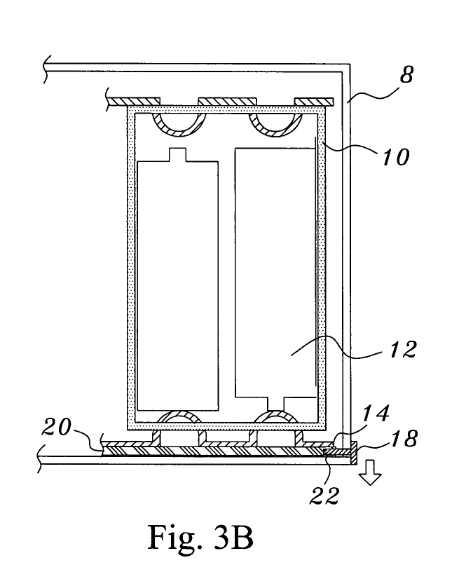

FIGS. 3A and 3B are structure diagrams showing the power-off step according to a third embodiment of the present invention. The third embodiment differs from the second embodiment in that the slidable component 20 slides vertically. When the user manually pushes the power-off switch 18, the slidable component 20 moves vertically and drives the two batteries 12 to leave from the conducting strip 14 at the upper end of the accommodating room 10 at the same time, hence forming an open circuit and therefore totally cutting off the electricity of the digital camcorder 8.

To sum up, when a digital camcorder is not in use for a long time, the power-off switch can be used to separate the conducting strip from the battery so that the digital camcorder won't have any power consumption. The electricity in the digital camcorder can thus be kept for a long time. Moreover, when one wants to use a digital camcorder that is not in use for a long time, the power loss of the electronic device can be reduced to minimum to decrease the number of times of replacing or charging the battery, hence enhancing the convenience of use.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A power-off switch structure disposed on an electronic device, said electronic device having at least a battery, said battery having at least two electrode ends, said power-off switch structure comprising:
at least two conducting strips respectively abutting against said two electrode ends and used to provide electricity of said battery for said electronic device; and
a power-off switch connected to a fastening component made of insulating material, said fastening component moving in between said conducting strips and said electrode ends to isolate said conducting strips and said battery when said power-off switch is pushed.

2. The power-off switch structure as claimed in claim 1, wherein said conducting strips are made of elastic metal material.

3. The power-off switch structure as claimed in claim 1, wherein said battery is a primary battery or a secondary battery.

4. The power-off switch structure as claimed in claim 1, wherein said electronic device has an accommodating room for installation of said battery, said conducting strips and said fastening component.

5. The power-off switch structure as claimed in claim 1, wherein said power-off switch is disposed on an outside surface of said electronic device for convenient operation of user.

6. The power-off switch structure as claimed in claim 1, wherein said fastening component is located beside said conducting strips.

7. The power-off switch structure as claimed in claim 1, wherein said electronic device is a digital camera, a mobile phone, or a digital camcorder.

8. A power-off switch structure disposed on an electronic device, said electronic device having at least a battery, said battery having at least two electrode ends, said power-off switch structure comprising:
a first conducting strip and a second conducting strip, said first conducting strip being disposed on a slidable component, said first and second conducting strips respectively abutting against said two electrode ends and being used to provide electricity of said battery for said electronic device; and
a power-off switch having a connection portion connected to said slidable component, said connection portion driving said slidable component to move so as to separate said conducting strip on said slidable component from said battery when said power-off switch is pushed.

9. The power-off switch structure as claimed in claim 8, wherein said conducting strips are made of elastic metal material.

10. The power-off switch structure as claimed in claim 8, wherein said power-off switch is disposed on an outside surface of said electronic device for convenient operation of user.

11. The power-off switch structure as claimed in claim 8, wherein said connection portion is connected with said conducting strips by means of fastening.

12. The power-off switch structure as claimed in claim 8, wherein said slidable component can move horizontally or vertically.

13. The power-off switch structure as claimed in claim 8, wherein said battery is a primary battery or a secondary battery.

14. The power-off switch structure as claimed in claim 8, wherein said electronic device has an accommodating room for accommodating said battery and said conducting strips.

15. The power-off switch structure as claimed in claim 8, wherein said electronic device is a digital camera, a mobile phone, or a digital camcorder.
